(19) United States
(12) Patent Application Publication
(10) Pub. No.: US 2025/0267747 A1
(43) Pub. Date: Aug. 21, 2025

(54) Apparatus and Method for Providing Connected Car Service

(71) Applicants: Hyundai Motor Company, Seoul (KR); Kia Corporation, Seoul (KR)

(72) Inventor: Jae Yoon Ko, Yongin-Si (KR)

(21) Appl. No.: 18/804,358

(22) Filed: Aug. 14, 2024

(30) Foreign Application Priority Data
Feb. 21, 2024 (KR) 10-2024-0025166

(51) Int. Cl. H04W 76/19; H04W 4/44

(52) U.S. Cl. CPC H04W 76/19; H04W 4/44

(57) ABSTRACT

The present disclosure relates to an apparatus and method for providing a connected car service, which can effectively cope with unavailability of service due to a connection problem with a mobile communication network. An apparatus for providing a connected car service may include a mobile communication modem connected to a mobile communication network to perform data exchange, and a connected car service terminal configured to detect a connection failure associated with the mobile communication network, send a first reconnection request based on whether a predetermined retry condition is satisfied, and send a second reconnection request regardless of whether the predetermined retry condition is satisfied.

### CROSS REFERENCE TO RELATED APPLICATION

The present application claims priority to Korean Patent Application No. 10-2024-0025166, filed on Feb. 21, 2024, the entire content of which is incorporated herein for all purposes by this reference.

### BACKGROUND

### Field

The present disclosure relates to an apparatus and method for providing a connected car service, which can effectively cope with a service unavailability situation due to a connection problem with a mobile communication network.

### INTRODUCTION

Many of the recently released vehicles support a connected car service (CCS) for providing various pieces of information such as weather information and traffic information through wireless communication. To support CCS functionality, it may be necessary to mount a CCS terminal on the vehicle for communicating with a CCS system (e.g., a server) for providing CCS through a mobile communication wireless communication network.

The CCS terminal may need to perform a wireless communication network opening procedure (e.g., initial procedure) in advance to connect to a mobile communication network of a service provider, and after the opening procedure, ideally there should be no problem with the connection to the communication network until communication with the network is terminated. However, while the CCS terminal tries to maintain its connection to the mobile communication network, a temporary or long-term failure (e.g., overload) in the communication network may occur, which may cause connection degradation or failure of the service.

If a similar problem occurs in a mobile terminal, such as a smartphone, a user may immediately attempt to reconnect to the network by, for example, simply turning a power source off and on. However, this may be infeasible or more difficult for a CCS terminal in a vehicle because a wireless communication modem connected to the CCS terminal may be reset only by removing and then reconnecting a battery of the vehicle. Thus, it may be burdensome for a user to try to remove and then reconnect the battery.

The matters explained in this introduction are for the purpose of enhancing the understanding of the background of the present disclosure and should not be taken as acknowledging that they correspond to the related art already known to those skilled in the art.

### BRIEF SUMMARY

According to one or more example embodiments of the present disclosure, an apparatus may include: a mobile communication modem configured to exchange data with a mobile communication network; and a connected car service terminal. The connected car service terminal may be configured to, based on detecting connection failure associated with the mobile communication network: send, via the mobile communication modem and to the mobile communication network, a first reconnection request based on whether a predetermined retry condition is satisfied; and send, based on receiving a service request, a second reconnection request regardless of whether the predetermined retry condition is satisfied.

The predetermined retry condition may include at least one of: the connection failure being a new connection failure, or a retry timer has expired.

The connected car service terminal may be configured to send the first reconnection request by sending, based on the connection failure being the new connection failure, the first reconnection request without starting the retry timer.

The connected car service terminal may be further configured to start the retry timer based on a failed attempt to reconnect to the mobile communication network after the new connection failure.

The retry timer may be adjusted by a connected car service server.

The connected car service terminal may be further configured to determine, based on a wireless network connection state message transmitted from the mobile communication modem, whether a connection to the mobile communication network is in a normal state.

The connected car service terminal may be further configured to determine the connection failure based on a value of the wireless network connection state message being other than a home network or a roaming network.

The apparatus may be included in a vehicle.

According to one or more example embodiments of the present disclosure, a method may include: determining, via a mobile communication modem, a status of a connection between a connected car service terminal and a mobile communication network; in response to the status indicating a connection failure, sending, via the mobile communication modem and to the mobile communication network, a first reconnection request based on whether a predetermined retry condition is satisfied; and sending, based on receiving a service request, a second reconnection request regardless of whether the predetermined retry condition is satisfied.

The predetermined retry condition may include at least one of: the connection failure being a new connection failure, or a retry timer being expired.

Sending the first reconnection request may include sending, based on the connection failure being the new connection failure, the first reconnection request without starting the retry timer.

The method may further include starting the retry timer based on a failed attempt to reconnect to the mobile communication network after the new connection failure.

The retry timer may be adjusted by a connected car service server.

Determining the status of the connection may include determining the status of the connection based on a wireless network connection state message transmitted from the mobile communication modem.

Determining the status of the connection may include determining the connection failure based on a value of the wireless network connection state message is set to a value other than a value corresponding to a home network or a roaming network.

### BRIEF DESCRIPTION OF THE DRAWINGS

FIG. 1 shows an example of an environment configuration for providing a connected car service according to an exemplary embodiment of the present disclosure.

FIG. 2 shows an example of a process of recovering the connected car service.

FIG. 3 shows an example of an operation process of the connected car service.

### DETAILED DESCRIPTION

Hereinafter, embodiments disclosed in this specification will be described in detail with reference to the accompanying drawings, and the same or similar components are denoted by the same reference numerals regardless of the drawing symbols, and overlapping descriptions thereof will be omitted. The suffixes “module” and “unit” for components used in the following description are given or used interchangeably in consideration of ease of preparing the specification and not have meanings or roles that are distinct from each other by themselves. In addition, in describing the embodiments disclosed in this specification, when it is determined that a detailed description of a related known technology may obscure the gist of the embodiments disclosed in this specification, a detailed description thereof will be omitted. In addition, the accompanying drawings are only for easy understanding of the embodiments disclosed in the specification, and it should be understood that the technical spirit disclosed in the specification is not limited by the accompanying drawings, and all changes, equivalents, or substitutes included in the spirit and technical scope of the present disclosure are included in the accompanying drawings.

Terms including ordinal numbers such as first or second may be used to describe various components, but the components are not limited by the terms. The terms are used only for the purpose of distinguishing one component from another.

When a first component is described as being “connected” or “coupled” to a second component, it should be understood that the first component may be directly connected or coupled to the second component or a third component may be present therebetween. On the other hand, when the first component is described as being “directly connected” or “directly coupled” to the second component, it should be understood that the third component is not present therebetween.

The singular expression includes the plural expression unless the context clearly dictates otherwise.

In the specification, it should be understood that the term “comprise” or “have” is intended to specify that a feature, a number, a step, an operation, a component, a part, or a combination thereof described in the specification is present, but do not preclude the possibility of the presence or addition of one or more other features, numbers, steps, operations, components, parts, or combinations thereof.

In addition, a unit or control unit included in the name of a motor control unit (MCU) or the like is merely the term widely used for naming a controller for controlling a specific function of a vehicle and does not mean a generic function unit. For example, each controller may include a communication device for communicating with another controller for controlling functions in charge, a memory for storing an operating system, logic commands, input/output information, and the like, and one or more processors for performing determination, calculation, decision, and the like necessary for controlling the functions in charge. “Terminal” described below may also have a configuration similar to the controller.

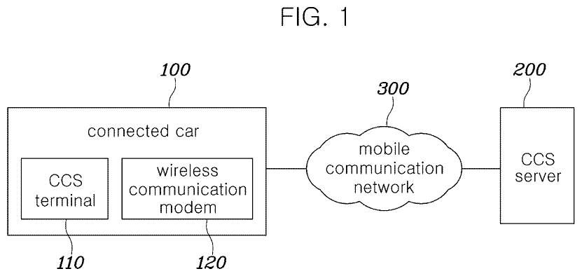

FIG. 1 shows an example of an environment configuration for providing a connected car service according to one embodiment.

Referring to FIG. 1, the connected car service according to the embodiment can be implemented through a vehicle 100 (hereinafter referred to as “connected car”) provided with each of a connected car service (CCS) terminal 110 and a wireless communication modem 120, a CCS server 200 for providing a CCS service, and a mobile communication network 300 for relaying data exchange between a wireless communication modem 120 and the CCS server 200.

When determining that a user's instruction input or predetermined (e.g., preset) service output conditions are satisfied, the CCS terminal 110 may request the service to the CCS server 200 via the mobile communication network 300 through the wireless communication modem 120. In addition, when a service response is received through the wireless communication modem 120, the corresponding guidance information may be output through a predetermined output means (e.g., a display or a speaker). In this case, the input device or output means for receiving the above-described user instruction may be provided integrally with the CCS terminal 110 itself or may be provided inside the connected car 100 separately from the CCS terminal 110.

The wireless communication modem 120 may be electrically connected to the CCS terminal 110 to enable operation and communication, may perform wireless communication according to a predetermined wireless communication protocol (e.g., 4G/LTE or 5G) through the connection to the mobile communication network 300 under control of the CCS terminal 110, and report its own state (e.g., status) or a connection state to the mobile communication network 300 to the CCS terminal 110.

The mobile communication network 300 may be referred to as a wireless communication network, and an operation thereof may be managed by service providers. When the wireless communication modem 120 tries to be connected to the mobile communication network 300, the mobile communication network 300 normally allows the connection when the CCS terminal 110 is normally opened, but may disconnect (e.g., “network reject”) the wireless communication modem 120 or reject the connection to the wireless communication modem 120 due to an overload or temporary failure of the network even when the mobile communication network 300 and the wireless communication modem 120 are normally already connected. In this case, the wireless communication modem 120 may report a connection failure to the CCS terminal 110.

As an example, the connection failure report may be a form of wireless network connection state report. More specifically, the wireless network connection state may have six code values such as NOSEARCHING=0, HOMENETWORK=1, UNREGISTERED=2, NETWORKREJECT=3, UNKNOWN=4, and ROAMINGNETWORK=5. Among these, an abnormal state (i.e., a connection failure) is a case of having the code value rather than the home network (HOMENETWORK=1) and the roaming network (ROAMINGNETWORK=5) and may mean a data communication (IP) connection failure state of a dedicated line (APN) between the modem 120 and the mobile communication network 300. Therefore, the CCS terminal 110 may determine that the connection state is not normal (i.e., the connection failure) when the wireless communication modem 120 reports a code value other than “1” or “5” as the connection state. However, the above-described connection state determination method is illustrative and is not necessarily limited thereto.

When determining the connection failure state of the wireless communication modem 120 to the mobile communication network 300, the CCS terminal 110 may try to be reconnected to the network in a method of resetting the wireless communication modem 120 or the like. In this case, the CCS terminal 110 may perform reconnection try depending on whether a predetermined (e.g., preset) retry condition is satisfied. Specifically, when the connection failure state is determined for the first time (e.g., a new connection failure is detected), reconnection may be tried immediately, but when the connection failure state is not the first determination, for example, when the reconnection tried after the first determination fails, the retry timer may be set, and when the retry timer expires (i.e., is ended), reconnection may be tried. Depending on implementation, the reconnection by the retry timer may also be performed only until a predetermined (e.g., preset) maximum number of times is reached. A value of the retry timer and the number of maximum times of the retry timer are intended to enable service providers to respond to a communication network load problem, may be set upon shipment from a factory, and adjusted by the CCS server 200. As an example, the CCS server 200 may adjust the value of the retry timer and the maximum number of times of the retry timer by acquiring battery information (e.g., a state of charge (SOC)) of the connected car 100, but is not necessarily limited thereto.

In addition, the value of the retry timer and the maximum number of times of the retry timer may be set differently depending on whether the connected car 100 is started to prevent the battery of the vehicle from being discharged. For example, to prepare for a vehicle battery discharge issue when an engine is turned off, the value of the timer may be set larger and the maximum number of times of the timer may be set lower than those when the engine is turned on.

Meanwhile, when only the method using the above-described retry timer is applied, even when a customer directly requests a service through a predetermined menu manipulation or the like, the reconnection try is not made before the reconnection timer has expired, and thus service provision unavailability guidance may be output through the CCS terminal, thereby making the customer inconvenient. Therefore, even when the retry timer is not ended in a situation in which the CCS terminal 110 according to the embodiment activates the retry timer as the reconnection try due to the first connection failure determination fails, the reconnection try may be made by resetting the wireless communication modem 120 regardless of the retry timer (e.g., even if the retry timer has not expired) when a service request occurs. A service request, for example, may be a user request via the CCS terminal (e.g., via a button press, a touch screen tap, etc.) to access the mobile communication network (e.g., to send or receive data). Therefore, when the service request does not occur, a load on the mobile communication network 300 is reduced by following a predetermined (e.g., preset) timer, and when the service request occurs, the customer satisfaction of the connected car 100 may be increased by trying to provide the service through immediate reconnection try.

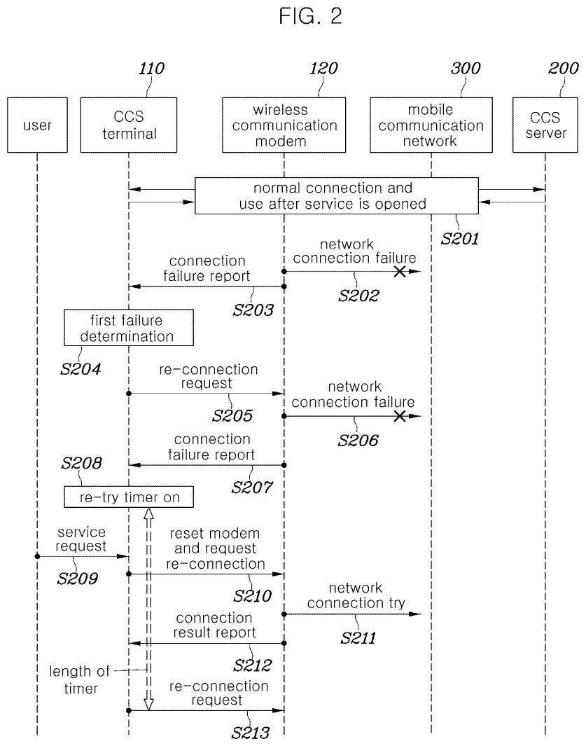

Hereinafter, a specific form in which the CCS recovery according to the embodiment is performed when network connection fails based on the CCS provision environment described above with reference to FIG. 1 will be described with reference to FIG. 2.

FIG. 2 shows an example a process of recovering the connected car service according to one embodiment.

Referring to FIG. 2, the CCS terminal 110 normally provides the connected car service through communication with the CCS server 200 in a state in which network opening to the mobile communication network 300 is normally (successfully) completed through the wireless communication modem 120 (S201).

However, the wireless communication modem 120 may fail to be connected to the network, such as rejection to network connection, due to a network overload or temporary system error of the mobile communication network 300 (S202).

Therefore, the wireless communication modem 120 may report the network connection failure to the CCS terminal 110 through a message in a predetermined (e.g., preset) format, such as wireless network connection state report (S203).

When the CCS terminal 110 receives the network connection failure report for the first time after normal network connection (S204), network reconnection may be performed in a method of resetting the wireless communication modem 120 or the like (S205). As described above, the network connection failure reported by the wireless communication modem 120 may mean a case rather than code 1 or 5 when the wireless network connection state is indicated by codes of 0 to 5, but it is illustrative, and the present disclosure is not necessarily limited thereto.

When the CCS terminal 110 fails to be connected (S206) and the connection failure report is re-received from the wireless communication modem 120 (S207) even when the reconnection to the network is made due to the first failure (S205), the CCS terminal 110 may set the retry timer (S208).

When the retry timer has expired, the CCS terminal 110 will try to be reconnected to the network through the wireless communication modem 120 (S213), but when the service request occurs even before the retry timer has expired (S209), the CCS terminal 110 may allow the wireless communication modem 120 to perform network reconnection by resetting the wireless communication modem 120 regardless of the retry timer (S210). Therefore, the wireless communication modem 120 may try the network reconnection (S211) and report the result of the try to the CCS terminal 110 (S212).

In FIG. 2, as an example of the service request (S209), a user's instruction is shown as being input to the CCS terminal 110, but it is illustrative, and the present disclosure is not necessarily limited thereto. For example, the service request may occur depending on whether a predetermined (e.g., preset) service activation condition is satisfied from the CCS terminal 110. Specifically, when a weather service is set to be updated every hour, the CCS terminal 110 may determine that the service request occurs when a renewal time point arrives even before the retry timer has expired.

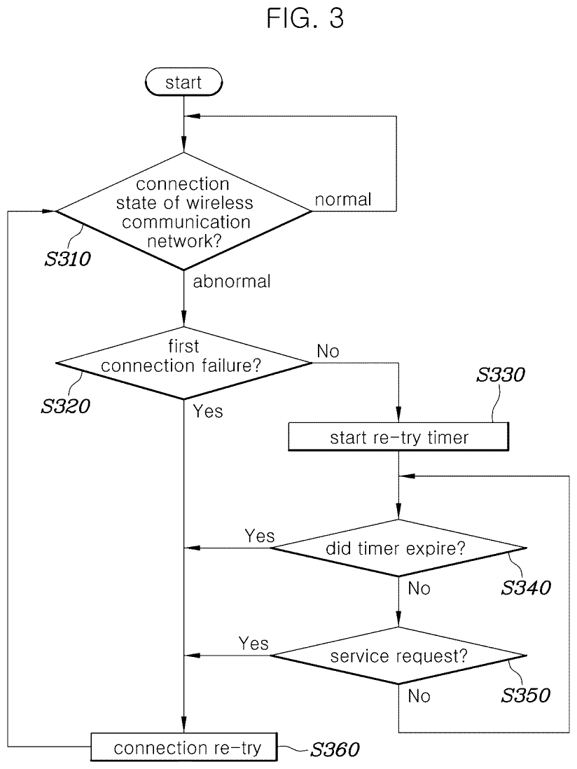

The operation of the CCS terminal in the above-described service recovery process is summarized in a flowchart shown in FIG. 3.

FIG. 3 shows an example of an operation process of the connected car service according to one embodiment.

Referring to FIG. 3, the CCS terminal 110 may determine the connection state of the wireless communication network through the wireless network connection state report of the wireless communication modem 120 or the like (S310). For example, as described above, when the wireless network connection state is indicated by codes of 0 to 5, the CCS terminal 110 may determine that the wireless network connection state is normal when receiving code 1 or 5 and determine the wireless network connection state is abnormal when receiving other codes.

When the wireless communication network connection state is determined to be abnormal (i.e., connection failure) (“abnormal” in S310) and the first connection fails (e.g., a connection failure is a new one and no attempt to reconnect has been made) (YES in S320), reconnection may be tried immediately (S360). Conversely, when the first connection does not fail (NO in S320), the CCS terminal 110 may start the retry timer (S330).

The CCS terminal 110 may perform the reconnection try if the retry timer has expired (YES in S340) or when the service request occurs (YES in S350) even though the retry timer is not ended (NO in S340) (S360).

According to the above-described embodiment, since the reconnection try is immediately performed by the occurrence of the service request in the service unavailability situation due to the connection problem with the mobile communication network, it is possible to effectively provide the connected car service. In particular, when the service request occurs, the reconnection try may be performed regardless of the timer even before the reconnection try by the retry timer, it is possible to quickly recover the service.

Various aspects of the present disclosure are directed to providing an apparatus and method for providing a connected car service, which can effectively cope with a service unavailability situation due to a connection problem with a mobile communication network.

The objects to be achieved in an exemplary embodiment of the present disclosure are not limited to the above-described object, and other objects that are not mentioned will be able to be clearly understood by those skilled in the art to which the present disclosure pertains from the following description.

To achieve the object, an apparatus for providing a connected car service according to one embodiment of the present disclosure may include a mobile communication modem connected to a mobile communication network to perform data exchange, and a connected car service terminal configured to perform reconnection try through the mobile communication modem depending on whether a preset re-try condition is satisfied when it is determined that normal connection to the mobile communication network fails, and control the reconnection try to be performed regardless of whether the re-try condition is satisfied when a service request occurs.

For example, the re-try condition may include a case in which the connection failure is a first connection failure and a case in which a preset try timer is ended.

For example, the connected car service terminal may control the reconnection try to be immediately performed when the connection failure is the first time.

For example, the connected car service terminal may start the re-try timer when the reconnection try due to the first connection failure fails.

For example, the re-try timer may be adjusted by a connected car service server.

For example, the connected car service terminal may determine whether it is normally connected to the mobile communication network based on a wireless network connection state message transmitted from the mobile communication modem.

For example, the connected car service terminal may determine that it fails to be connected normally when a code value of the wireless network connection value message is set to a value other than a value corresponding to a home network or a roaming network.

In addition, a vehicle according to one embodiment may include the above-described apparatus for providing the connected car service.

In addition, a method of controlling a connected car service terminal according to one embodiment may include determining whether a connected car service terminal is normally connected to a mobile communication network through a mobile communication modem connected to the mobile communication network to perform data exchange, performing reconnection try through the mobile communication modem depending on whether a preset re-try condition is satisfied when it is determined that the connected car service terminal fails to be normally connected to the mobile communication network, and performing the reconnection try regardless of whether the re-try condition is satisfied when a service request occurs.

For example, the re-try condition may include a case in which the connection failure is a first connection failure and a case in which a preset try timer is ended.

For example, the performing of the reconnection try through the mobile communication modem depending on whether the preset re-try condition is satisfied may include immediately performing the reconnection try when the connection failure is the first time.

For example, the method may further include starting the re-try timer when the reconnection try according to the first connection failure fails.

For example, the re-try timer may be adjusted by a connected car service server.

For example, the determining may include determining whether the connected car service terminal is normally connected to the mobile communication network based on a wireless network connection state message transmitted from the mobile communication modem.

For example, the determining of whether the connected car service terminal is normally connected to the mobile communication network based on the wireless network connection state message may include determining that the connected car service terminal fails the normal connection when a code value of the wireless network connection value message is set to a value other than a value corresponding to a home network or a roaming network.

According to one embodiment of the present disclosure, since the reconnection try is immediately performed by the occurrence of service request in the service unavailability situation due to the connection problem with the mobile communication network, it is possible to effectively provide the connected car service.

In particular, when the service request occurs, the reconnection try can be performed regardless of the timer even before the reconnection try by the re-try timer, it is possible to quickly recover the service.

The effects obtainable from the present disclosure are not limited to the above-described effects, and other effects that are not mentioned will be able to be clearly understood by those skilled in the art to which the present disclosure pertains from the following description.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus comprising:
a mobile communication modem configured to exchange data with a mobile communication network; and
a connected car service terminal configured to, based on detecting a connection failure associated with the mobile communication network:
send, via the mobile communication modem and to the mobile communication network, a first reconnection request based on predetermined retry condition is satisfied; and
send, based on receiving a service request, a second reconnection request regardless of whether the predetermined retry condition is satisfied.

2. The apparatus of claim 1, wherein the predetermined retry condition comprises at least one of:
the connection failure being a new connection failure, or
a retry timer has expired.

3. The apparatus of claim 2, wherein the connected car service terminal is configured to send the first reconnection request by sending, based on the connection failure being the new connection failure, the first reconnection request without starting the retry timer.

4. The apparatus of claim 3, wherein the connected car service terminal is further configured to start the retry timer based on a failed attempt to reconnect to the mobile communication network after the new connection failure.

5. The apparatus of claim 2, wherein the retry timer is adjusted by a connected car service server.

6. The apparatus of claim 1, wherein the connected car service terminal is further configured to determine, based on a wireless network connection state message transmitted from the mobile communication modem, whether a connection to the mobile communication network is in a normal state.

7. The apparatus of claim 6, wherein the connected car service terminal is further configured to determine the connection failure based on a value of the wireless network connection state message being other than a home network or a roaming network.

8. The apparatus of claim 1, wherein the apparatus is comprised in a vehicle.

9. A method comprising:
determining, via a mobile communication modem, a status of a connection between a connected car service terminal and a mobile communication network;
in response to the status indicating a connection failure, sending, via the mobile communication modem and to the mobile communication network, a first reconnection request based on whether a predetermined retry condition is satisfied; and
sending, based on receiving a service request, a second reconnection request regardless of whether the predetermined retry condition is satisfied.

10. The method of claim 9, wherein the predetermined retry condition comprises at least one of:
the connection failure being a new connection failure, or
a retry timer being expired.

11. The method of claim 10, wherein the sending of the first reconnection request comprises sending, based on the connection failure being the new connection failure, the first reconnection request without starting the retry timer.

12. The method of claim 11, further comprising starting the retry timer based on a failed attempt to reconnect to the mobile communication network after the new connection failure.

13. The method of claim 10, wherein the retry timer is adjusted by a connected car service server.

14. The method of claim 9, wherein the determining of the status of the connection comprises determining the status of the connection based on a wireless network connection state message transmitted from the mobile communication modem.

15. The method of claim 14, wherein the determining of the status of the connection comprises determining the connection failure based on a value of the wireless network connection state message is set to a value other than a value corresponding to a home network or a roaming network.
